(19) United States
(12) Patent Application Publication
(10) Pub. No.: US 2025/0028570 A1
(43) Pub. Date: Jan. 23, 2025

(54) SPLIT-COMPUTE ARCHITECTURE

(71) Applicant: GOOGLE LLC, Mountain View, CA (US)

(72) Inventors: Mark Sander Urbanus, San Jose, CA (US); Patrick Plunkett, Santa Clara, CA (US); Charlie Gengzao Wang, Fremont, CA (US); Meltem Oktem, San Jose, CA (US); James Carr, San Francisco, CA (US)

(21) Appl. No.: 18/909,624

(22) Filed: Oct. 8, 2024

Related U.S. Application Data
(63) Continuation of application No. PCT/US2023/020056, filed on Apr. 26, 2023.
(63) Continuation of application No. PCT/US2023/020062, filed on Apr. 26, 2023.
(60) Provisional application No. 63/363,592, filed on Apr. 26, 2022.
(60) Provisional application No. 63/363,592, filed on Apr. 26, 2022.

(51) Int. Cl. G06F 9/50; G06F 9/54

(52) U.S. Cl. CPC G06F 9/505; G06F 9/54; G06F 2209/508; G06F 2209/544

(57) ABSTRACT

A method including initiating a computing process on a wearable device, the computing process including a plurality of tasks, identifying a companion device and determining that the companion device is available to perform at least one task of the plurality of tasks, causing the companion device to perform the at least one task including communicating data generated by the wearable device to the companion device, receiving, by the wearable device, a result associated with a completion of the at least one task by the companion device, and completing, by the wearable device, the computing process based on the result associated with the completion of the at least one task.

### CROSS-REFERENCE TO RELATED APPLICATION

This application is a continuation of PCT Application No. PCT/US2023/020056, filed Apr. 26, 2023, which claims the benefit and priority to U.S. Provisional Application No. 63/363,592, filed on Apr. 26, 2022, the disclosure of which is incorporated by reference herein in its entirety. This application is a continuation of PCT Application No. PCT/US2023/020062, filed Apr. 26, 2023, which claims the benefit and priority to U.S. Provisional Application No. 63/363,592, filed on Apr. 26, 2022, the disclosure of which is incorporated by reference herein in its entirety.

This application also incorporates by reference herein the disclosures to related co-pending applications, PCT Application No. PCT/US2023/019563, filed Apr. 24, 2023, PCT Application No. PCT/US2023/019832, filed Apr. 25, 2023, PCT Application No. PCT/US2023/020049, filed Apr. 26, 2023, PCT Application No. PCT/US2023/020061, filed Apr. 26, 2023.

### FIELD

Implementations relate to a wearable device processing architecture.

### BACKGROUND

Some devices (e.g., wearable devices) can have advanced display capabilities. These devices can be challenged to fit sufficiently capable electronics into a small form factor. These issues become increasingly challenging in applications, such as accessibility, where a device might be expected to be worn for a full day.

Existing commercially available systems cannot support continuous usage scenarios. For example, wearable devices (e.g., smart glasses, smart watches, head mounted displays, and the like) are intended for intermittent engagement and are built around phone-class System-on-Chips (SoCs). These devices can provide only a few hours of battery life with a display on. In addition, thermal comfort can be an issue due to the small volume head mounted displays.

### SUMMARY

Example implementations include a wearable device and a companion device using a split-compute architecture. To conserve wearable device resources, the companion device can process computing tasks that otherwise would be performed by the wearable device. The split-compute architecture facilitates the offloading of the computing tasks to the companion device.

In a general aspect, a device, a system, a non-transitory computer-readable medium (having stored thereon computer executable program code which can be executed on a computer system), and/or a method can perform a process with a method including initiating a computing process on a wearable device, the computing process including a plurality of tasks, identifying a companion device and determining that the companion device is available to perform at least one task of the plurality of tasks, causing the companion device to perform the at least one task including communicating data generated by the wearable device to the companion device, receiving, by the wearable device, a result associated with a completion of the at least one task by the companion device, and completing, by the wearable device, the computing process based on the result associated with the completion of the at least one task.

Example implementations include a wearable device and a companion device using a split-compute architecture. To conserve wearable device resources when processing data using a machine learning model, the companion device can process layers of the machine learning model that otherwise would be performed by the wearable device. The processing of the data can be offloaded from the wearable device to the companion device if communicating data uses fewer resources than processing the data using a layer of the machine learning model and/or if the companion device can improve the processing of the machine learning model.

In a general aspect, a device, a system, a non-transitory computer-readable medium (having stored thereon computer executable program code which can be executed on a computer system), and/or a method can perform a process with a method including communicatively coupling a wearable device with a companion device, initiating, by the wearable device, a computing process that includes a machine learning model including a plurality of layers, prior to processing data using a layer of the plurality of layers, determining, by the wearable device, whether to process the data using the wearable device or the companion device, in response to determining the wearable device is to process the data, processing, by the wearable device, the data using the layer, and in response to determining the companion device is to process the data, communicating, by the wearable device to the companion device, the data, information associated with the machine learning model, and information associated with the layer.

### BRIEF DESCRIPTION OF THE DRAWINGS

Example implementations will become more fully understood from the detailed description given herein below and the accompanying drawings, wherein like elements are represented by like reference numerals, which are given by way of illustration only and thus are not limiting of the example implementations.

FIG. 1 illustrates a block diagram of a high-level split-compute architecture according to an example implementation.

FIG. 2 illustrates a block diagram of the high-level split-compute architecture with a shared runtime environment according to an example implementation.

FIG. 3 illustrates a block diagram of a wearable device split-compute architecture according to an example implementation.

FIG. 4 illustrates a block diagram of a high-level split-compute architecture according to an example implementation.

FIG. 5 illustrates a block diagram of activity elements in a wearable device application according to an example implementation.

FIG. 6 illustrates a block diagram of a wearable device application in a wearable device runtime environment according to an example implementation.

FIG. 7 illustrates a block diagram of a system using a split-compute architecture according to an example implementation.

FIG. 8 is a block diagram of a method of operating a split-compute system according to an example implementation.

FIG. 9 is a block diagram of a method of operating a wearable device according to an example implementation.

FIG. 10 is a block diagram of a method of operating a companion device according to an example implementation.

FIG. 11 is a block diagram illustrating a machine learning model according to an example implementation.

FIG. 12 illustrates a block diagram of a system using a split-compute architecture according to an example implementation.

FIG. 13 is a block diagram of a machine learning model according to an example implementation.

FIG. 14 is a block diagram of a method of operating a wearable device according to an example implementation.

FIG. 15 is a block diagram of a method of operating a companion device according to an example implementation.

It should be noted that these Figures are intended to illustrate the general characteristics of methods, and/or structures utilized in certain example implementations and to supplement the written description provided below. These drawings are not, however, to scale and may not precisely reflect the precise structural or performance characteristics of any given implementation and should not be interpreted as defining or limiting the range of values or properties encompassed by example implementations. For example, the positioning of modules and/or structural elements may be reduced or exaggerated for clarity. The use of similar or identical reference numbers in the various drawings is intended to indicate the presence of a similar or identical element or feature.

### DETAILED DESCRIPTION

Wearable devices can provide only a few hours of battery life with a display on. For example, computationally expensive operations such as image rendering, distortion correction, location services, and/or the like for wearable display optics may not always be possible to execute efficiently on a low-power embedded system implemented in the wearable device. Therefore, display architectures for thin-client wearable devices (e.g., smart glasses), however, can have the opportunity to reduce device onboard power and thermal footprint, by offloading computation-intensive operations (e.g., graphics operations) to a companion device (e.g., a mobile device, a smartphone, a server, and/or the like).

Some wearable devices can have implementation constraints. For example, a smart glasses implementation constraint can include (1) smart glasses should amplify key services through wearable computing. This can include supporting technologies such as AR and visual perception. For example, a smart glasses implementation constraint can include (2) smart glasses should last a full day of use on a single charge. For example, a smart glasses implementation constraint can include (3) smart glasses should look and feel like real glasses. Wearable devices can include augmented reality (AR) and virtual reality (VR) devices. Wearable devices can include smart glasses, head worn devices, and/or head mount devices. The wearable devices, head worn devices, and/or head mount devices can be AR/VR devices. Fully stand-alone wearable devices (e.g., smart glasses) solutions with mobile SoCs that have the capability to support the desired features may not meet the power and industrial design constraints listed above. On-device compute solutions that meet constraints (1), (2) and (3) may be difficult to achieve with current technologies. Current technology is limited in that stand-alone solutions with mobile system on a chip (SoC) technologies that meet the functionality requirements won't meet the power and industrial design constraints listed above.

A split-compute architecture can be used to solve the problems associated with existing wearable devices technology implementations meeting the aforementioned constraints. A split-compute architecture can be an architecture that moves an application runtime environment to a remote compute endpoint, such as a smartphone, a server, the cloud, a desktop computer, and the like, hereinafter often referred to as a companion device. In some implementations, data sources such as an inertial measurement unit (IMU) and camera sensors can be streamed from the wearable device to the companion device. In some implementations, display content can be streamed from the companion device back to the wearable device. Continuing the smart glasses example, the majority of the compute and rendering does not happen on the smart glasses, therefore the split-compute architecture can allow leveraging low-power processor and/or low-power microcontroller MCU based systems. In some implementations, the split-compute architecture combined with a wearable device including an MCU can allow minimizing power usage, meeting constraints (1) and (2) and (3). With new innovation in codecs and networking, it is possible to sustain the required networking bandwidth in a low power manner. In some implementations, wearable devices can communicate with a companion device over a well-defined protocol. This architecture can be platform independent.

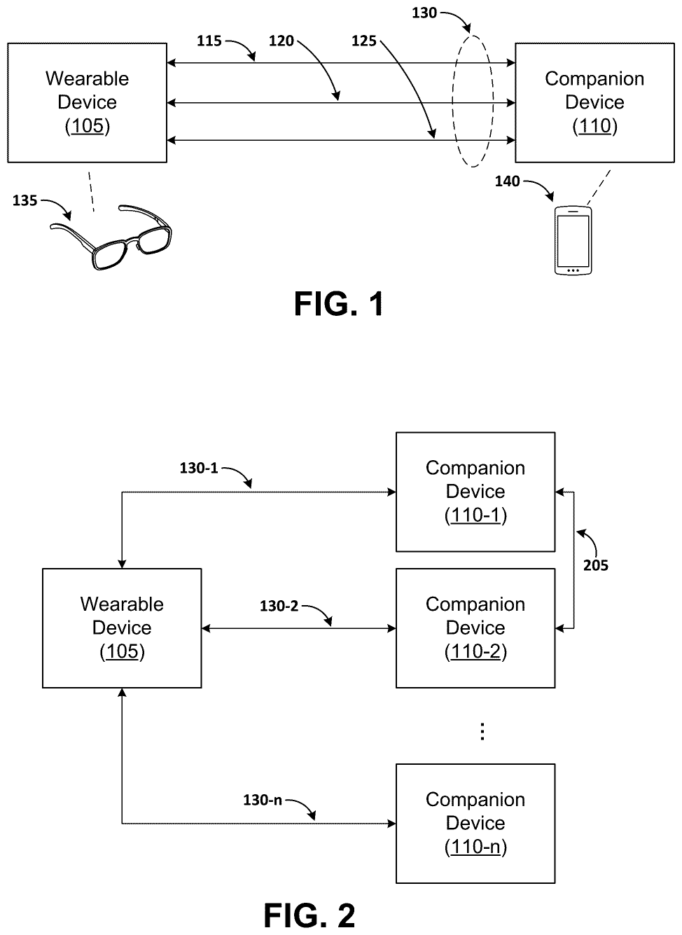

FIG. 1 illustrates a block diagram of a high-level split-compute architecture according to an example implementation. As shown in FIG. 1, the split-compute architecture can include a wearable device 105 and a companion device 110. In an example implementation, the wearable device 105 can be smart glasses, an augmented reality/virtual reality headset, a head mounted display (HMD), a smart watch, a smart ring, and/or the like. As an example, FIG. 1 shows the wearable device 105 as smart glasses 135. In an example implementation, the companion device 110 can be another wearable device, a mobile device, a smart phone, a tablet, a server, and a device including a processor and an operating system. As an example, FIG. 1 shows the companion device 110 as smart phone 140.

The wearable device 105 and the companion device 110 can be communicatively coupled. For example, the wearable device 105 and the companion device 110 can be communicatively coupled wired or wirelessly. In other words, the wearable device 105 and the companion device 110 can be endpoints of a two-way, wired and/or wireless, communication link. As an example, the wearable device 105 and the companion device 110 can communicate an audio stream and/or video stream over communications line 115. As an example, the wearable device 105 and the companion device 110 can communicate data (e.g., IMU, camera, input, and/or the like) over communications line 120. As an example, the wearable device 105 and the companion device 110 can communicate a control stream over communications line 125. Communications line 115, communications line 120, and/or communications line 125 can be referred to collectively as communications line 130. In some implementations, the communications line 130 can be bi-directional.

In some implementations, the companion device 110 can include a runtime environment the wearable device 105 can connect to. In some implementations, the wearable device 105 can stream data such as IMU and camera imagery into the runtime environment. In some implementations, the runtime environment of the companion device 110 can be configured to perform the tracking, perception and/or application rendering and/or deliver the output back to the wearable device 105 through a graphics application programming interface (API), such as encoded video or rendering commands. In some implementations, the runtime environment can be a code or software application and/or container executing on the companion device 110. In some implementations, the runtime environment can be software operating on the companion device 110 at the same time as the wearable device 105 and/or during a time when the wearable device 105 and the companion device 110 are communicatively coupled. In some implementations, input is captured from the wearable device 105 and injected into (e.g., communicated to) the runtime environment of the companion device 110.

As an example, absent the companion device 110, a computing process would entirely be executed on the wearable device 105. The computing process can be any computing process associated with the function of the wearable device. For example, the computing process can be a computing process configured to display content (e.g., as an image or video) on a display of the wearable device 105. The computing process can be any computing process including at least one task (or a plurality of tasks). The at least one task can be computer instructions (e.g., code) stored on a memory of the wearable device 105 that are executed by a processor of the wearable device 105. The at least one task can be computer instructions (e.g., code) stored on a memory of the companion device 110 that are executed by a processor of the companion device 110.

The at least one task can be computer instructions (e.g., code) configured to generate a result. The result can be an intermediate result or output of the computing process. The result can be a completed or final result or output of the computing process. The at least one task can be instructions executed by the processor of the wearable device 105. The at least one task can be instructions executed by the processor of the companion device 110. In some implementations, a task(s) can be implemented as a service. A service can be, for example, a machine-to-machine interaction over a network. A service can be implemented as a background operation. For example, a service can perform network transactions, play audio, perform I/O, interact with a content provider, and/or the like from the background.

By including the companion device 110 (e.g., the runtime environment of the companion device 110), device onboard power usage and thermal footprint can be reduced by offloading one or more tasks of the plurality of tasks to the companion device 110. In an example implementation, the plurality of tasks can be fragmented. Fragmenting tasks can include methodically and/or randomly assigning plurality of tasks between the wearable device 105 and the companion device 110. For example, methodically assigning plurality of tasks between the wearable device 105 and the companion device 110 can be based on resource usage. For example, if the amount of resources used to cause a task (or tasks) to be executed (noting that executing a task includes performing computer operations) on the companion device 110 is greater than executing the task (or tasks) on the wearable device 105, then the task (or tasks) can be executed on the wearable device 105.

For example, a task (or tasks) can include and/or use computer data (e.g., a high-resolution image captured by a camera of the wearable device 105). If communicating the computer data uses more resources (e.g., battery resources of the wearable device 105) than a task including processing the data by the wearable device 105, the wearable device 105 should be assigned to complete the task. Otherwise, the companion device 110 should be assigned to complete the task. In this example implementation, both the wearable device 105 and the companion device 110 are capable of performing the task (or tasks). In some implementations, two or more companion devices may be used to complete the process including the plurality of tasks.

FIG. 2 illustrates a block diagram of the high-level split-compute architecture with a shared runtime environment according to an example implementation. As shown in FIG. 2, the wearable device 105 is communicatively coupled to two or more companion devices 110-1, 110-2, . . . 110-n via communications lines 130-1, 130-2, . . . 130-n respectively. In some implementations, the wearable device 105 could roam between various companion devices 110-1, 110-2, . . . 110-n, selecting the companion devices 110-1, 110-2, . . . 110-n that provides the best experience at that point in time. The wearable device 105 can connect to multiple companion devices 110-1, 110-2, . . . 110-n runtimes simultaneously. Therefore, the wearable device 105 can connect to multiple runtime environments simultaneously.

For example, the runtime environment associated with companion device 110-1 can be configured to project content onto a display of the wearable device 105 while the runtime environment associated with companion device 110-2 can be configured to access the data sources (e.g., sensors) from the wearable device 105, a database server, the internet, and/or the like for processing. In addition, or alternatively, the companion devices 110-1, 110-2, . . . 110-n can be communicatively coupled (e.g., wired or wirelessly) to share resources and/or data. For example, companion device 110-1 and companion device 110-2 can be communicatively coupled enabling the runtime environment associated with companion device 110-1 to receive data from the runtime environment associated with companion device 110-2 for use when the runtime environment associated with companion device 110-2 generates images (or frames) to project content onto the display of the wearable device 105.

For example, companion device 110-1 and companion device 110-2 can be communicatively coupled (e.g., via communications line 205) enabling the runtime environment associated with companion device 110-2 to share processing resources with the runtime environment associated with companion device 110-1. For example, the runtime environment associated with companion device 110-1 may be instructed to generate content (e.g., an image, a frame, a map, and/or the like) that is more efficiently generated by the runtime environment associated with companion device 110-2. For example, companion device 110-2 may include a map database and map (e.g., image) generator. The runtime environment associated with companion device 110-1 may be instructed to generate content that includes a map. In this example, the runtime environment associated with companion device 110-1 can request a map from the runtime environment associated with companion device 110-2.

Continuing the example above, should a determination be made that the companion device 110 is to perform the task(s), the companion device 110 (or the wearable device 105) can determine that two or more companion devices 110 can perform the task(s). For example, the task(s) can include generating content (e.g., an image) to be displayed on the wearable device 105. In this example, the companion device 110-1 can be configured to generate the content. However, data used to generate the content may be generated by the companion device 110-2 which is then communicated (e.g., via communications line 205) from the companion device 110-2 to the companion device 110-1. For example, the companion device 110-2 can be a wearable smart watch configured to sense a user heart rate. Data representing the heart rate can be communicated from the companion device 110-2 to the companion device 110-1. Then, the companion device 110-1 can generate content using the data representing the heart rate and the content can be communicated to the wearable device 105 for display on a display of the wearable device 105.

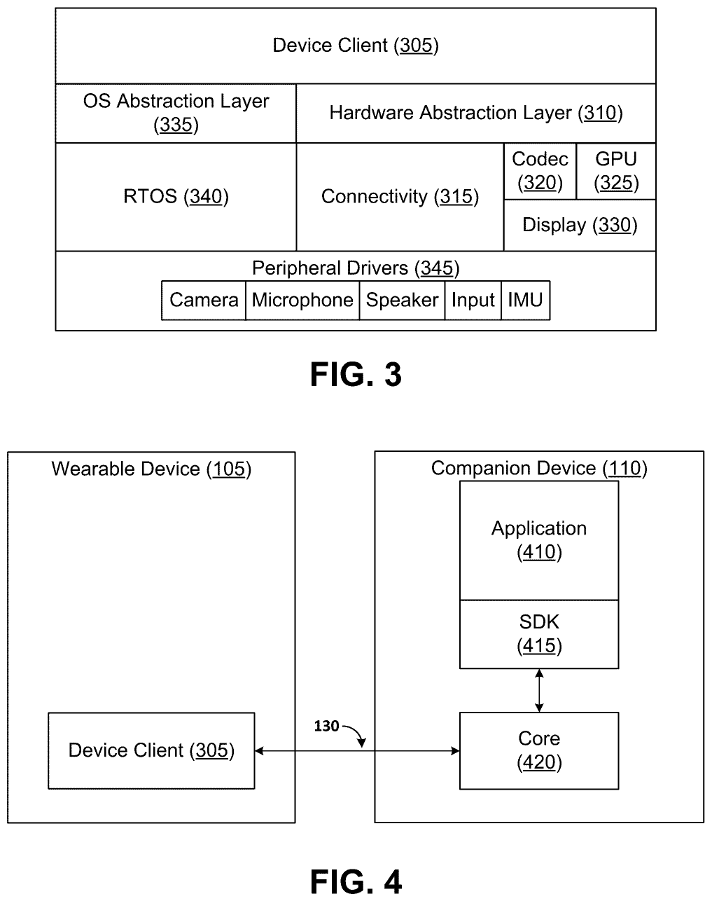

FIG. 3 illustrates a block diagram of a wearable device split-compute architecture according to an example implementation. As shown in FIG. 3, the wearable device split-compute architecture can include a hardware abstraction layer (HAL) 310 block. The HAL 310 can be a layer of software configured to interface between an operating system (e.g., RTOS 340) and a hardware device at a general or abstract level rather than at a hardware level. In some implementations, using abstraction layers can make the split-compute architecture platform independent. The HAL 310 can be called from the operating system kernel. In some implementations, the HAL 310 can be a virtual HAL. The virtual HAL can minimize interpretation latency based on the similarity in architectures of a guest and a host platform. Virtualization technique helps map the virtual resources to physical resources and use the native hardware for computations in the virtual HAL.

Accordingly, as an example, the HAL 310 can include a connectivity 315 block, a codec 320 block, a graphics processing unit (GPU) 325 block, and a display 330 block each configured to interface with a corresponding hardware device. For example, the connectivity 315 can be configured to interface between the operating system (e.g., RTOS 340) and Bluetooth hardware, WIFI hardware, ultra-wideband (UWB) hardware, 5G hardware, and/or the like. Therefore, the wearable device split-compute architecture can be configured to utilize any connectivity hardware designed into the wearable device 105.

For example, the codec 320 can be configured to interface between the operating system (e.g., RTOS 340) and an encoder and/or a decoder (e.g., a hardware-based encoder and/or decoder). The codec 320 standard can be, for example, H.265, H.264, MPEG, VP9, machine learned, and/or the like. The codec 320 can be an image, video, and/or audio codec. Therefore, the wearable device split-compute architecture can be configured to utilize any codec software and/or hardware designed into the wearable device 105. For example, the GPU 325 can be configured to interface between the operating system (e.g., RTOS 340) and GPU hardware (e.g., a GPU ASIC). Therefore, the wearable device split-compute architecture can be configured to utilize any GPU (e.g., to render an image on a display system) designed into the wearable device 105. For example, the display 330 can be configured to interface between the operating system (e.g., RTOS 340) and display hardware (e.g., a wearable device display). Therefore, the wearable device split-compute architecture can be configured to utilize any display (e.g., display driver system) designed into the wearable device 105.

As shown in FIG. 3, the wearable device split-compute architecture can include an operating system (OS) abstraction layer (OSAL) 335. In some implementations, using abstraction layers can make the split-compute architecture platform independent. The OSAL 335 can be configured to provide an interface to common system functions offered by the OS of the wearable device 105. These OSAL 335 can simplify development and porting software (e.g., applications) to multiple OS and hardware platforms. In some implementations, the OSAL 335 can operate as (or similar to) an application programming interface (API). In some implementations, the OSAL 335 can be platform dependent.

The OSAL 335 can include a real-time operating system (RTOS) 340 block. The RTOS 340 can be configured to process, for example, multi-threaded applications to meet real-time deadlines. For example, the RTOS 340 can be configured to process a plurality of tasks each (or a grouping of tasks) having a maximum completion time. Although an RTOS is illustrated, any OS can be used. For example, a high-level operating system (HLOS) can be used. In a split-compute system, using tasks enables distribution of these tasks (or groups of tasks) between computing devices. For example, a content display operation for the wearable device 105 can be divided between the wearable device 105 and the companion device 110 (e.g., the runtime environment associated with companion device 110). In other words, the wearable device 105 (and/or the companion device 110) can be configured to (e.g., using the wearable device split-compute architecture) cause the companion device 110 to perform a portion (a task or a grouping of tasks) of a process (e.g., content display).

As shown in FIG. 3, the wearable device split-compute architecture can include a peripheral drivers 345 block. The peripheral drivers 345 can be configured to interface between the OS and a peripheral device. For example, the wearable device 105 can include a plurality of peripheral devices including, for example, a camera(s), a microphone(s), a speaker(s), an input(s), an inertial measurement unit(s) (IMU), and/or the like. Therefore, the peripheral drivers 345 can be configured to interface between the RTOS 340 and the peripheral device(s) of the wearable device 105.

As shown in FIG. 3, the wearable device split-compute architecture can include a device client 305. The device client 305 can be configured to control communication between the wearable device 105 and the companion device 110. For example, device client 305 can be configured to generate, initialize, and control the communications line 130 and the communications over the communications line 130. The communications line 130 can operate as, for example, a socket (e.g., a network socket, a TCP/IP network socket, and the like). A socket can be one endpoint of a two-way communication link between computer code (e.g., applications, programs, software systems, and/or the like) running on two computing devices. The socket mechanism can be configured to provide inter-process communication (IPC) by establishing named communication contact points between two endpoints and/or between two endpoints and an intermediate device (e.g., an access point (AP)). A socket can be configured to provide a bidirectional first-in first-out (FIFO) communication channel. A socket connecting to the network is created at each end of the communication. As an example, each socket can have an address (or memory location). The address (or memory location) can be, for example, an IP address and a port number. Accordingly, the device client 305 can be configured to write to and read from a socket associated with the companion device 110 (or the runtime environment associated with companion device 110). In some implementations, the device client 305 can be platform independent.

In some implementations, a software development kit (SDK) can be associated with the wearable device 105 and the companion device 110. The SDK can be used when developing applications for the wearable device 105 and/or the companion device 110. The SDK can enable the implementation of the split-compute architecture. Therefore, any wearable device 105 and/or companion device 110 (regardless of the hardware and/or software platform) that includes the split-compute architecture can us an application that was developed using the SDK. Therefore, an application does not have to be developed and ported to each hardware and/or software platform that may be used as a wearable device 105 and/or the companion device 110. The SDK can be included (or have elements that can be included) with the application when the application is installed on the wearable device 105 and/or the companion device 110.

FIG. 4 illustrates a high-level split-compute architecture according to an example implementation. As shown in FIG. 4, a system can include the wearable device 105 and the companion device 110. The split-compute architecture for the system can include a device client 305 block associated with the wearable device 105, an application 410 block, an SDK 415 block, and a core 420 block associated with the companion device 110. As mentioned above, the device client 305 can be configured to control communication between the wearable device 105 and the companion device 110. The core 420 can be configured to control communication between the companion device 110 and the wearable device 105. Accordingly, the core 420 can be configured to, at least, generate, initialize, and control the communications line 130 and the communications over the communications line 130. The communications line 130 can operate as, for example, a socket (as described above).

In some implementations, the application 410 can include the file format for applications used on the OS that holds the application logic (e.g., the Android package kit (APK)). In some implementations, wearable device applications can link with a stub (e.g., not a complete) version of the SDK to support compile and testing services. In some implementations, at runtime, the application 410 can load the wearable device SDK 415 directly from a wearable device runtime environment. In some implementations, the SDK 415 can provide developers the application programming interface (API) used to build wearable device applications. In some implementations, an API versioning scheme allows introduction of new APIs while maintaining backwards compatibility. In some implementations, the wearable device runtime environment can be a collection of core services responsible for maintaining the wearable device execution environment. In some implementations, wearable device applications may not interact with the core services directly. In some implementations, one or more interaction may go through the SDK. In some implementations, the device client 305 can be a thin client running on the wearable device 105 hardware.

As an example, the application 410 can be configured to generate (or help generate) content for display on the wearable device 105. For example, the application can be configured to process a task(s). For example, the application can generate the content (e.g., as an image) and communicate the content to the core 420 via the SDK 415. Communicating the content to the core 420 via the SDK 415 can be one of the features that allows the application 410 to be developed for any hardware and/or software platform. For example, the SDK 415 can be configured to communicate with the application 410 when the application 410 is developed. The SDK 415 can also be configured to communicate with the core 420 associated with a plurality of hardware and/or software platforms. After receiving the content, the core 420 can communicate the content to the wearable device 105 via the device client 305 using, for example, a pre-established socket.

As mentioned above, in some implementations, the wearable device 105 can be configured to connect to more than one companion device 110 at a given time. In some implementations, a different companion device 110 can be configured to provide different services (e.g., using an application 410). In some implementations, with low-latency, high-bandwidth 5G connections becoming mainstream, the companion device 110 can be configured to operate in the cloud (e.g., connecting through 5G standards).

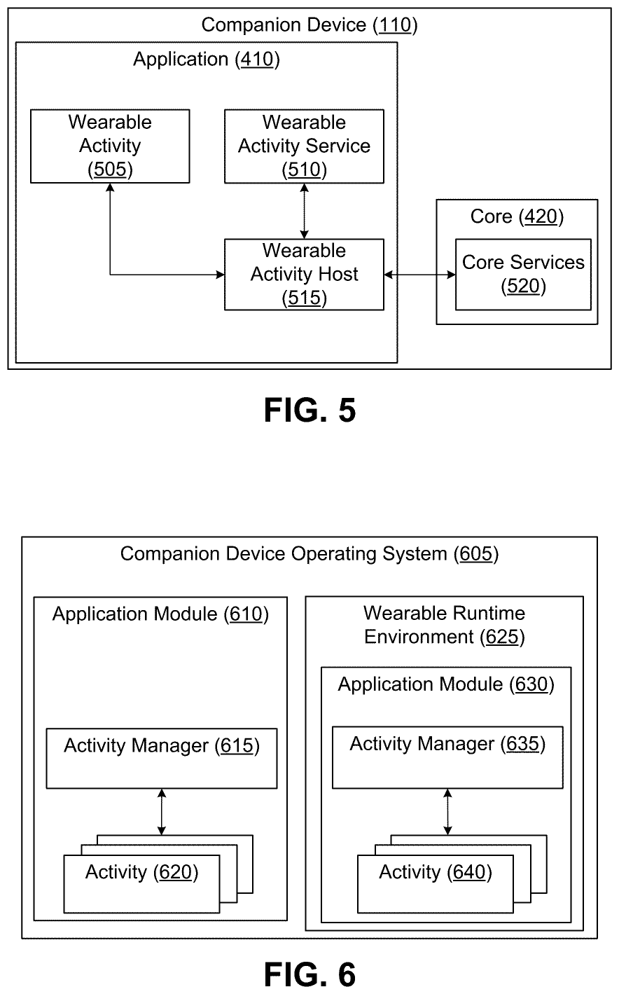

FIG. 5 illustrates a block diagram of activity elements in a wearable device application according to an example implementation. As shown in FIG. 5, the application 410 can include a wearable activity 505 block, a wearable activity service 510 block, and a wearable activity host 515 block, and the core 420 can include a core services 520 block.

In some example implementations, wearable device application design can resemble an activity model. Referring to FIG. 3, the RTOS 340 can be configured to process, a task, a plurality of tasks each (or a grouping of tasks) having a maximum completion time. Therefore, each activity can be a task executed in a parallel process and having a time (or amount of time) to be completed by.

In an example implementation, activities can be executed in a service context. In some implementations, running in a service context can allow the application 410 to run concurrently with companion device 110 applications. In some implementations, the application can continue running and rendering when a companion device 110 display is off.

In some implementations, one or more application 410 can include a wearable activity service 510. The wearable activity service 510 can be configured to expose the wearable activity 505 so that the wearable activity 505 can be instantiated by the SDK 415. Therefore, the wearable activity 505 can be instantiated at a later point in time. From a developer's point of view, the wearable activity service 510 can be boilerplate code that does not directly relate to application 410 logic. The wearable activity 505 can be the code related to application 410 logic. In some implementations, wearable activity 505 can be managed by an activity manager and behave similarly to a standard OS activity counterpart.

In some implementations, the service binding can be used by the wearable device runtime environment to start and manage the life cycle of the application 410. Once the activity manager binds to the service as part of a launch flow, the SDK 415 can instantiate and attach a wearable activity host 515 as, for example, a class that can be responsible for general activity state control. For example, during initialization the wearable activity host 515 can request a surface from a window manager. This surface is then used as a backing store for a virtual display that's used to render the contents of the application 410.

FIG. 6 illustrates a block diagram of a wearable device application in a wearable device runtime environment according to an example implementation. As shown in FIG. 6, a companion device OS 605 can simultaneously process two or more application environments. For example, the companion device OS 605 can include an application module 610. The application module 610 can be associated with standard OS application activity. In addition, the companion device OS 605 can include an application module 630 operating in association with a wearable runtime environment 625. The wearable runtime environment 625 can be associated with the wearable device 105.

An activity(s) 620, 640 can be a single, focused task that the application can perform. For example, some applications can include a user interface (UI). Therefore, the activity(s) 620, 640 can be configured to create a window to place the UI. The window can be a full-screen window, a floating window, embedded into other windows, a hidden window, and/or the like. The different types of windows can be associated with different activity(s) 620, 640.

The activity(s) 620, 640 can be configured for any task, a window is just one example. The activity manager 615, 635 can be configured to communicate information about, and interact with the activities 620, 640. The activity manager 615, 635 can be further configured to communicate information about, and interact with tasks, threads, services and other processes.

In an example implementation, the wearable runtime environment 625 can be a virtual runtime environment. The virtual runtime environment can be configured to operate in the background of a computing device. Therefore, the wearable runtime environment 625 can be a virtual runtime environment associated with the wearable device 105 and configured to operate as a background process on the companion device 110. In other words, the wearable runtime environment 625 can operate without a user interface shown on a display of the companion device 110. For example, the wearable runtime environment 625 can operate in a hidden window of the companion device 110. Therefore, a user of the companion device 110 may have no visual or I/O control of an application using the wearable runtime environment 625 if the wearable runtime environment 625 is a virtual runtime environment.

In an alternative, or additional implementation, the application 410 and/or the application module 630 can be a virtual process. The virtual process can be configured to operate in the background of a computing device. Therefore, the application 410 and/or the application module 630 can be a virtual process associated with the wearable device 105 and configured to operate as a background process on the companion device 110. In other words, the application 410 and/or the application module 630 can operate without a user interface shown on a display of the companion device 110. For example, the application 410 and/or the application module 630 can operate in a hidden window of the companion device 110. Therefore, a user of the companion device 110 may have no visual or I/O control of the application 410 and/or the application module 630 if the process is a virtual runtime process.

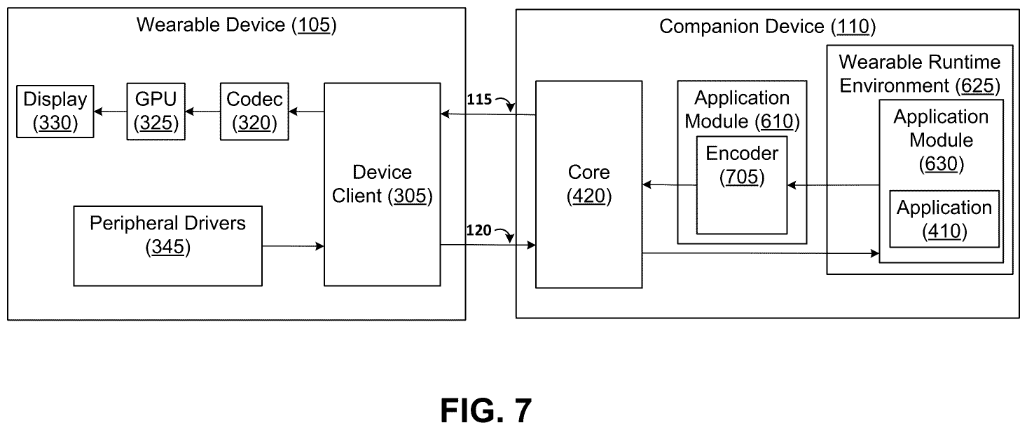

FIG. 7 illustrates a block diagram of a system using a split-compute architecture according to an example implementation. As shown in FIG. 7, the system includes the wearable device 105 and the companion device 110. The wearable device 105 can include the device client 305, the codec 320, the GPU 325, the display 330, and the peripheral drivers 345. The companion device 110 can include the core 420, the application module 610 including an encoder 705, and the application module 630 including the application 410. This example implementation can be used to describe a signal flow associated with generating and displaying content on the wearable device 105 using the split-compute architecture described herein. This is just one of many possible system configurations and uses, other configurations uses can exist and are within the scope of this disclosure.

In this example implementation, the application 410 can be configured to generate content for display on the wearable device 105. The application 410 can be configured to generate content based on data received from the wearable device 105. For example, the peripheral drivers 345 can sense and communicate data, as peripheral data, (e.g., IMU data) to the application module 630 via the device client 305 and the core 420 using the communications line 120. In other words, peripheral data can be the data that is collected by and/or processed by (e.g., compressed, packaged, parsed, filtered, denoised, and/or the like) the peripheral device via the peripheral drivers 345 and packaged for communication with and use by the wearable device 105 and/or the companion device 110. The application 410 can generate the content as, for example, a rendered image and/or frame. The encoder 705 can compress the image and/or frame (e.g., using the H.264 codec). The compressed image and/or frame can be communicated to the wearable device 105 via the core 420 and the device client 305 using the communications line 115. The codec 320 can decompress the image and/or frame (e.g., using the H.264 codec). The GPU 325 can cause the image and/or frame to be displayed on the display 330.

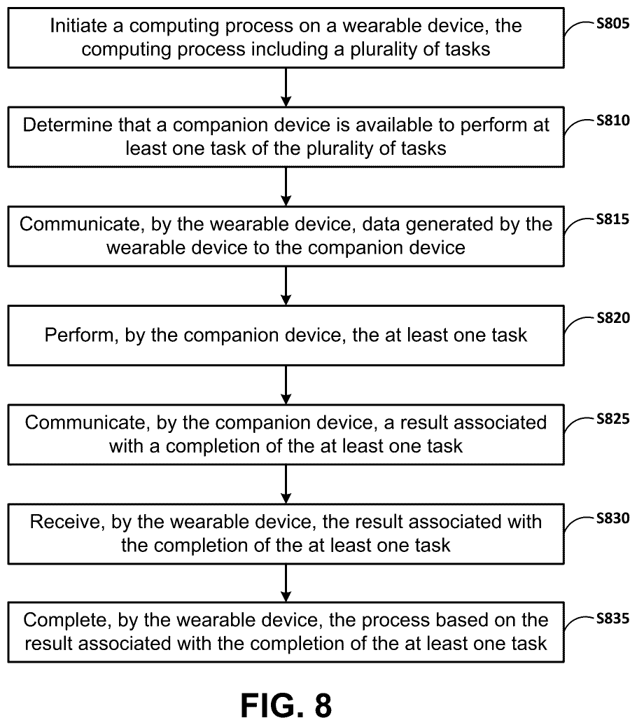

Example 1. FIG. 8 is a block diagram of a method of operating a split-compute system including a wearable device and a companion device communicatively coupled to the wearable device according to an example implementation. As shown in FIG. 8, in step S805 a computing process is initiated on the wearable device, the computing process including a plurality of tasks. For example, the computing process can be initiated by a user of the wearable device providing corresponding user input (e.g., a gesture) to the wearable device. In some implementations, the wearable device can initiate the computing process based on another computing process, based on a spatial position of the wearable device, and/or the like. In step S810 the companion device is determined to be available to perform at least one task of the plurality of tasks. For example, the companion device can be identified by the wearable device as an available companion device on a list of potential available companion devices stored in a memory of the companion device. Alternatively, the available companion device could be any companion device in the proximity of the wearable device that can establish a connection with the wearable device via a Two-Way or Three-Way Handshake (e.g., handshaking can be bi-directional in that both the client and the host determine what capabilities each support). The available companion device can signal to the wearable device a list of tasks that the companion device is capable of performing, or the wearable device can be already aware of the tasks a particular type of companion device is capable of. In step S815 the wearable device communicates data generated by the wearable device to the companion device. For example, the data can comprise IMU and camera imagery, and/or metadata relating to the imagery. In step S820 the companion device performs the at least one task. For example, the companion device can automatically perform the at least one task upon receiving the data. In step S825 the companion device communicates a result associated with a completion of the at least one task. Here, the term result can be used to refer to the processed data. In step S830 the wearable device receives the result associated with the completion of the at least one task. In step S835 the wearable device completes the computing process based on the result associated with the completion of the at least one task. Here, the wearable device can combine the processed data received from the companion device with further processed data associated with the completion of the remaining tasks of the plurality of tasks by the wearable device.

Example 2. The method of Example 1, wherein the companion device can be a first companion device and the at least one task is at least one first task, the system can further include a second companion device the system can be configured to cause the second companion device to perform at least one second task of the plurality of tasks. Causing a device to perform a task can include sending an instruction configured to initiate processing and/or trigger processing of a task by the device and/or another device(s).

Example 3. The method of Example 2, wherein the first companion device and the second companion device can be communicatively coupled.

Example 4. The method of Example 1, wherein the wearable device can be smart glasses.

Example 5. The method of Example 1, wherein the companion device can be at least one of another wearable device, a mobile device, a smart phone, a tablet, a server, and a device including a processor and an operating system.

Example 6. The method of Example 1, wherein the runtime environment can be a virtual runtime environment operating as a background process on the companion device.

Example 7. The method of Example 6, wherein the at least one task can include an application, and the at least one task can further include processing an output of the application.

Example 8. The method of Example 7, wherein processing the output of the application can include rendering an image on a display of the wearable device.

Example 9. The method of Example 7, wherein the device client can be configured to control communication associated with the application.

Example 10. The method of Example 1, wherein the computing process can be initiated by the wearable device.

Example 11. The method of Example 1, wherein the computing process can be initiated by the companion device.

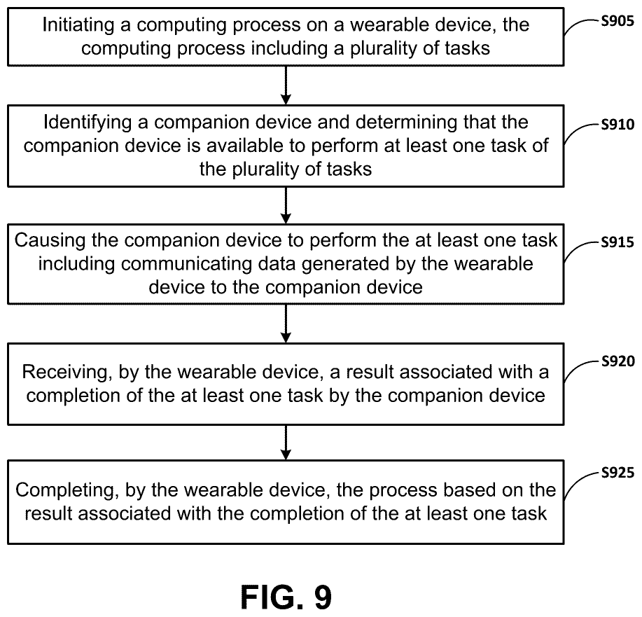

Example 12. FIG. 9 is a block diagram of a method of operating a wearable device according to an example implementation. As shown in FIG. 9, in step S905 a computing process is initiated on a wearable device, the computing process including a plurality of tasks. In step S910 a companion device is identified and determining that the companion device is available to perform at least one task of the plurality of tasks. In step S915 the companion device is caused to perform the at least one task including communicating data generated by the wearable device to the companion device. In step S920 the wearable device receives a result associated with a completion of the at least one task by the companion device. In step S925 the wearable device completes the computing process based on the result associated with the completion of the at least one task.

Example 13. The method of Example 12, wherein the result is a first result, the method can further include receiving, by the wearable device, a second result associated with processing of the at least one task by the companion device, processing, by the wearable device, the second result as a processed second result, and communicating, by the wearable device to the companion device, the processed second result, wherein the result associated with the completion of the at least one task by the companion device can be based on the processed second result. Here, the term second result can be used to refer to intermediate processed data and the term first result can be used to refer to the final processed data.

Example 14. The method of Example 12, wherein the computing process can be initiated by the wearable device.

Example 15. The method of Example 12, wherein the computing process can be initiated by the companion device and initiating the computing process on the wearable device can include receiving a trigger from the companion device, by the wearable device.

Example 16. The method of Example 12, wherein the data can be associated with a peripheral device of the wearable device.

Example 17. The method of Example 12, wherein the wearable device can include a first socket, the companion device can include a second socket communicatively coupled to the first socket, the method can further include causing the companion device to perform the at least one task includes writing an instruction and the data to the first socket and receiving the result associated with a completion of the at least one task includes reading the result from the second socket.

Example 18. The method of Example 12, wherein the result can include an image, the method further comprising displaying the image on a display of the wearable device.

Example 19. The method of Example 12, wherein the wearable device can be smart glasses.

Example 20. The method of Example 12, wherein the companion device can be at least one of another wearable device, a mobile device, a smart phone, a tablet, a server, and a device including a processor and an operating system.

Example 21. The method of Example 12, wherein the companion device can include a virtual runtime environment, causing the companion device to perform the at least one task can include causing the virtual runtime environment to perform the computing process, the result can be the completion of the computing process, and completing, by the wearable device, the computing process can be based on the result includes rendering an image on a display of the wearable device.

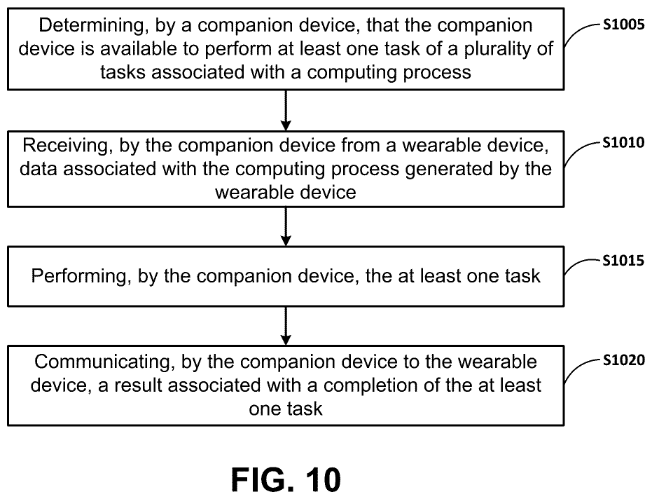

Example 22. FIG. 10 is a block diagram of a method of operating a companion according to an example implementation. As shown in FIG. 10, in step S1005 a companion device determines that the companion device is available to perform at least one task of a plurality of tasks associated with a computing process. In step S1010 the companion device receives data associated with the computing process generated by the wearable device. In step S1015 the companion device performs the at least one task. In step S1020 the companion device communicates a result associated with a completion of the at least one task.

Example 23. The method of Example 22, wherein the result is a first result, the method can further include communicating, by the companion device to the wearable device, a second result associated with processing of the at least one task by the companion device, receiving, by the companion device from the wearable device, a processed second result, and completing the at least one task by the companion device based on the processed second result, wherein the first result is based on the processed second result.

Example 24. The method of Example 22, wherein the computing process can be initiated by the wearable device.

Example 25. The method of Example 22, wherein the computing process can be initiated by the companion device, the method can further include communicating, by the companion device to the wearable device, a trigger associated with initiating the computing process.

Example 26. The method of Example 22, wherein the data can be associated with a peripheral device of the wearable device.

Example 27. The method of Example 22, wherein the wearable device can include a first socket, the companion device can include a second socket communicatively coupled to the first socket, the method can further include causing the companion device to perform the at least one task includes reading an instruction and the data from the second socket and communicating the result associated with a completion of the at least one task includes writing the result to the second socket.

Example 28. The method of Example 22, wherein the result can include an image.

Example 29. The method of Example 22, wherein the wearable device can be smart glasses.

Example 30. The method of Example 22, wherein the companion device can be at least one of another wearable device, a mobile device, a smart phone, a tablet, a server, and a device including a processor and an operating system.

Example 31. The method of Example 22, wherein the companion device can include a virtual runtime environment, causing the companion device to perform the at least one task can include causing the virtual runtime environment to perform the plurality of tasks, the result can be the completion of the plurality of tasks.

Example 32. A method can include any combination of one or more of Example 1 to Example 31.

Example 33. A non-transitory computer-readable storage medium comprising instructions stored thereon that, when executed by at least one processor, are configured to cause a computing system to perform the method of any of Examples 1-32.

Example 34. An apparatus comprising means for performing the method of any of Examples 1-32.

Example 35. An apparatus comprising at least one processor and at least one memory including computer program code, the at least one memory and the computer program code configured to, with the at least one processor, cause the apparatus at least to perform the method of any of Examples 1-32.

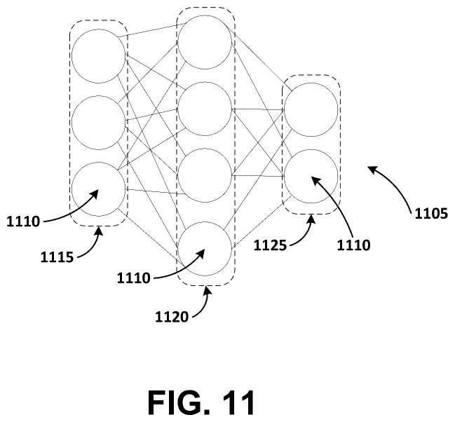

FIG. 11 is a block diagram illustrating a machine learning model according to an example implementation. Example implementations can include a machine learning model 1105. As shown in FIG. 11, the machine learning model 1105 can include a plurality of layers in a convolutional neural network with no sparsity constraints. The layered neural network can include three (s) layers 1115, 1120, 1125. Each layer 1115, 1120, 1125 can be formed of a plurality of neurons 1110. In this implementation, no sparsity constraints have been applied. Therefore, all neurons 1110 in each layer 1115, 1120, 1125 are networked to all neurons 1110 in any neighboring layers 1115, 1120, 1125. If sparsity constraints were applied, all neurons 1110 in each layer 1115, 1120, 1125 would not be networked to all neurons 1110 in any neighboring layers 1115, 1120, 1125.

In an example implementation, each layer 1115, 1120, 1125 can be processes on the wearable device 105 and/or the companion device 110. For example, layer 1115 can be processes on the wearable device 105 and layers 1120 and 1125 can be processes on the companion device 110. The wearable device 105 can be configured to determine whether or not layer 1115, 1120, 1125 can be processes on the wearable device 105 or the companion device 110. In an example implementation, each neuron 1110 can be processes on the wearable device 105 and/or the companion device 110. The wearable device 105 can be configured to determine whether or not neurons 1110 can be processes on the wearable device 105 or the companion device 110.

In an example implementation, the wearable device 105 can be configured to determine whether or not layer 1115, 1120, 1125 and/or neurons 1110 can be processed on the wearable device 105 or the companion device 110 based on a comparison of the resources used to communicate the data for processing to the companion device 110 and the resources used to process the data (e.g., process a layer and/or neuron) on the wearable device 105. For example, if communicating the data uses more resources than processing the data, the wearable device 105 can process the data. For example, if communicating the data uses fewer resources than processing the data, the wearable device 105 can communicate the data for processing by the companion device 110.

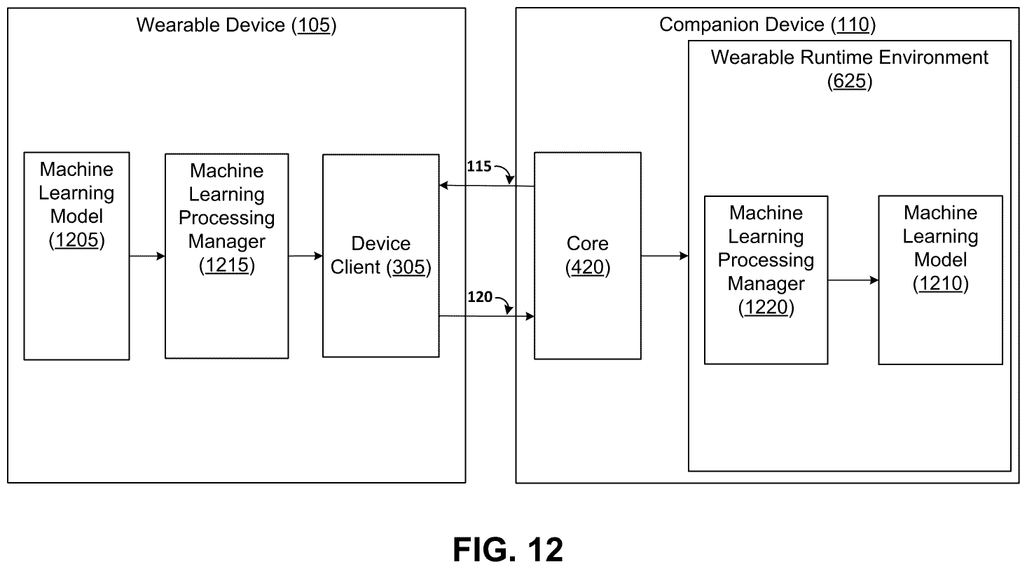

FIG. 12 illustrates a block diagram of a system using a split-compute architecture according to an example implementation. As shown in FIG. 12, the system includes the wearable device 105 and the companion device 110. The wearable device 105 can include the device client 305, a machine learning model 1205, and a machine learning processing manager 1215. The companion device 110 can include the core 420 and the wearable runtime environment 625. The wearable runtime environment 625 can include a machine learning model 1210, and a machine learning processing manager 1220.

In an example implementation, the machine learning model 1205 and the machine learning model 1210 are configured to generate the same output based on an input. In other words, the machine learning model 1205 and the machine learning model 1210 are a same machine learning model trained using the same training data. In an example implementation, the machine learning model 1205 is a trained machine learning model that has been copied to generate the machine learning model 1210. In order to simplify the description of FIG. 12, the machine learning model 1205 and the machine learning model 1210 can have the structure of the machine learning model 1105.

Initially, the machine learning model 1205 can be triggered with input data (e.g., an image captured using a camera of the wearable device 105). Prior to the wearable device 105 processing the input data using the machine learning model 1205, the machine learning processing manager 1215 can determine whether or not the layer 1115 of the machine learning model 1205 should be used to process the input data. For example, if communicating the input data to the companion device 110 uses more resources than processing the input data, the wearable device 105 can process the input data using layer 1115 of the machine learning model 1205. However, if communicating the input data uses fewer resources than processing the input data, the wearable device 105 can communicate the input data for processing by the companion device 110 using layer 1115 of the machine learning model 1210.

In this example, the machine learning processing manager 1215 can determine the layer 1115 of the machine learning model 1205 is to be used to process the input data. After processing the input data using the layer 1115 of the machine learning model 1205 and before processing the resultant data using the layer 1120 of the machine learning model 1205, the machine learning processing manager 1215 can determine whether or not the layer 1120 of the machine learning model 1205 should be used to process the resultant data.

In this example, the machine learning processing manager 1215 can determine the layer 1120 of the machine learning model 1205 is not to be used to process the input data. For example, communicating the resultant data can use fewer resources than processing the resultant data. Therefore, the wearable device 105 can communicate the resultant data for processing by the companion device 110 using layer 1120 of the machine learning model 1210. For example, the machine learning processing manager 1215 can communicate the resultant data and information about the machine learning model 1205 (e.g., an identification of the machine learning model) and a processing status of the data (e.g., the next layer to be used and a mapping of the data to (each of) the plurality of neurons 1110). The communication can be directed to the machine learning processing manager 1220 via the device client 305 and the core 420.

The machine learning processing manager 1220 can be configured to direct or input the data (e.g., using the map the data to each of the plurality of neurons 1110) to layer 1120 (e.g., the neurons 1110 layer 1120) of the machine learning model 1210 and cause the data to be processed by layer 1120 of the machine learning model 1210 and then by layer 1125 of the machine learning model 1210. The output of the layer 1125 of the machine learning model 1210 can be the output of the machine learning model 1210 which should be equivalent to the output of the machine learning model 1205 had the wearable device 105 completed the process.

Further, a similar determination by the machine learning processing manager 1215 of whether or not to process data by a neuron 1110 of the machine learning model 1205 can be made. In this scenario, the data associated with an input of a neuron 1110 of the machine learning model 1205 can be communicated together with information about the neuron 1110. Moving the processing of the data by the machine learning model from the wearable device 105 to the companion device 110 can conserve resources of the wearable device 105.

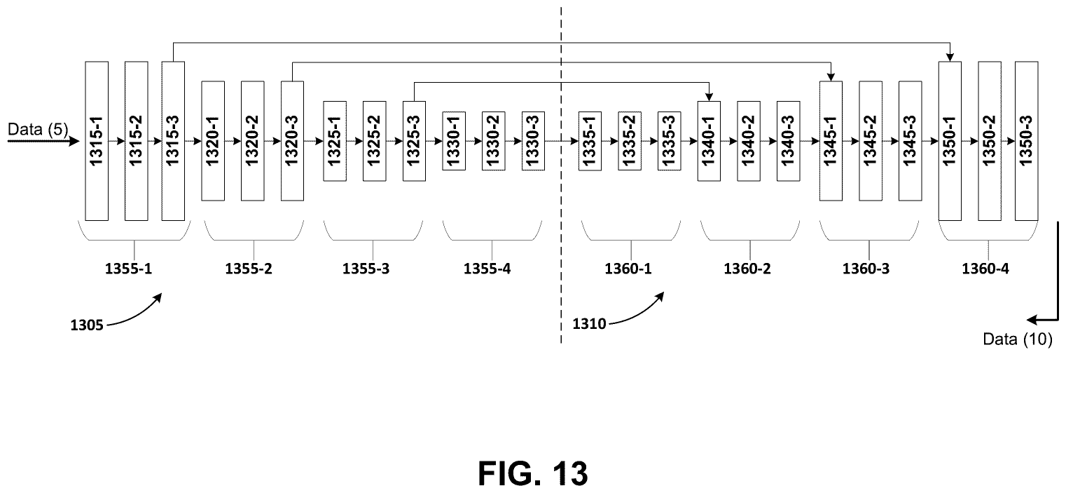

FIG. 13 is a block diagram illustrating a machine learning model (e.g., an auto encoder, an encoder-decoder network, gaze detection, head pose, object recognition, and/or the like) according to an example implementation. The machine learning model of FIG. 13 can represent a machine learning model processed on the wearable device 105 and/or the companion device 110. The machine learning model of FIG. 13 can include a first machine learning model 1305 and a second machine learning model 1310. In an example implementation, the first machine learning model 1305 can be configured to be processed on the wearable device 105 and the second machine learning model 1310 can be configured to be processed on the wearable device 105. In an example implementation, the first machine learning model 1305 can be configured to be processed on the companion device 110 and the second machine learning model 1310 can be configured to be processed on the companion device 110. In an example implementation, the first machine learning model 1305 can be configured to be processed on the wearable device 105 and/or the companion device 110 and the second machine learning model 1310 can be configured to be processed on the wearable device 105 and/or the companion device 110. In an example implementation, a portion of the first machine learning model 1305 can be configured to be processed on the wearable device 105 and/or the companion device 110 and a portion of the second machine learning model 1310 can be configured to be processed on the wearable device 105 and/or the companion device 110. Processing of first machine learning model 1305 and the second machine learning model 1310 can be any combination of the aforementioned example implementations.

A machine learning model can include at least one convolution layer(s) or convolution(s). For example, as shown in FIG. 13, the machine learning model 1305 can include four (4) convolution layers each including three (3) convolutions where a first convolution layer 1355-1 includes convolutions 1315-1, 1315-2, 1315-3, a second convolution layer 1355-2 includes convolutions 1320-1, 1320-2, 1320-3, a third convolution layer 1355-3 includes convolutions 1325-1, 1325-2, 1325-3, and a fourth convolution layer 1355-4 includes convolutions 1330-1, 1330-2, 1330-3. Further, as shown in FIG. 13, the machine learning model 1310 can include four (4) convolution layers each including three (3) convolutions, where a first convolution layer 1360-1 includes convolutions 1335-1, 1335-2, 1335-3, a second convolution layer 1360-2 includes convolutions 1340-1, 1340-2, 1340-3, a third convolution layer 1360-3 includes convolutions 1345-1, 1345-2, 1345-3, and a fourth convolution layer 1360-4 includes convolutions 1350-1, 1350-2, 1350-3. The machine learning model can include skip connection(s) (e.g., the output of convolution 1315-3 can be communicated as input to convolution 1350-1) and other computations needed to realize the machine learning model outputs.

A convolution layer (e.g., convolution layer 1355-1, 1355-2, 1355-3, 1355-4, 1360-1, 1360-2, 1360-3, and/or 1360-4) or convolution can be configured to extract features from data 5 (e.g., an image) as input data. Features can be based on color, frequency domain, edge detectors, and/or the like. A convolution can have a filter (sometimes called a kernel) and a stride. For example, a filter can be a 1×1 filter (or 1×1×n for a transformation to n output channels, a 1×1 filter is sometimes called a pointwise convolution) with a stride of 1 which results in an output of a cell generated based on a combination (e.g., addition, subtraction, multiplication, and/or the like) of the features of the cells of each channel at a position of the M×M grid. In other words, a feature map having more than one depth or channel is combined into a feature map having a single depth or channel. A filter can be a 3×3 filter with a stride of 1 which results in an output with fewer cells in/for each channel of the M×M grid or feature map. The output can have the same depth or number of channels (e.g., a 3×3×n filter, where n=depth or number of channels, sometimes called a depthwise filter) or a reduced depth or number of channels (e.g., a 3×3×k filter, where k<depth or number of channels). Each channel, depth, or feature map can have an associated filter. Each associated filter can be configured to emphasize different aspects of a channel. In other words, different features can be extracted from each channel based on the filter (this is sometimes called a depthwise separable filter). Other filters are within the scope of this disclosure.

Another type of convolution can be a combination of two or more convolutions. For example, a convolution can be a depthwise and pointwise separable convolution. This can include, for example, a convolution in two steps. The first step can be a depthwise convolution (e.g., a 3×3 convolution). The second step can be a pointwise convolution (e.g., a lxi convolution). The depthwise and pointwise convolution can be a separable convolution in that a different filter (e.g., filters to extract different features) can be used for each channel or each depth of a feature map. In an example implementation, the pointwise convolution can transform the feature map to include c channels based on the filter. For example, an 8×8×3 feature map can be transformed to an 8×8×256 feature map based on the filter. In some implementations more than one filter can be used to transform the feature map to an M×M×c feature map.

A convolution can be linear. A linear convolution describes the output, in terms of the input, as being linear time-invariant (LTI). Convolutions can also include a rectified linear unit (ReLU). A ReLU is an activation function that rectifies the LTI output of a convolution and limits the rectified output to a maximum. A ReLU can be used to accelerate convergence (e.g., more efficient computation).

In an example implementation, a combination of depthwise convolutions and depthwise and pointwise separable convolutions can be used. Each of the convolutions can be configurable (e.g., configurable feature, stride and/or depth). For example, the machine learning model 1305 can include convolutions 1315-1, 1315-2, 1315-3, 1320-1, 1320-2, 1320-3, 1325-1, 1325-2, 1325-3, 1330-1, 1330-2, and 1330-3 that can transform the data 5 into a code representation (sometimes called a feature map). The machine learning model 1310 can include convolutions 1335-1, 1335-2, 1335-3, 1340-1, 1340-2, 1340-3, 1345-1, 1345-2, 1345-3, 1350-1, 1350-2, and 1350-3 that can incrementally transform the code representation into the data 10 as output data. Data 10 can output the trained output result. For example, data 10 can represent a reconstructed image in an encoder-decoder model, a gaze direction, head pose, an object identification, and/or the like.

In an example implementation, the first machine learning model 1305 can be included on and configured to be processed by the wearable device 105. Further, the first machine learning model 1305 and the second machine learning model 1310 can be included on and configured to be processed by the companion device 110. In an example implementation, the machine learning model 805 can be triggered with data 5 (e.g., an image captured using a camera of the wearable device 105). Prior to the wearable device 105 processing the data 5 using the first convolution layer 1355-1, the machine learning processing manager 815 can determine whether or not the first convolution layer 1355-1 should be used to process the data 5. For example, if communicating the data 5 to the companion device 110 uses more resources than processing the data 5 using the first convolution layer 1355-1, the wearable device 105 can process the data 5 using the first convolution layer 1355-1. However, if communicating the data 5 uses fewer resources than processing the data 5, the wearable device 105 can communicate the data 5 for processing by the companion device 110 using first convolution layer 1355-1 on the companion device 110.

As an example, determining a quantity of resources used by the wearable device 105 to communicate data can be based on a size of the data (e.g., a number of bits, bytes, megabytes, etc.) and resources used to process (e.g., format, compress, packetize and/or the like) a unit (e.g., a bit, byte, megabyte, etc.) of data. The resources used to process a unit of data can be predetermined (e.g., previously measured) for the wearable device 105 and stored on the wearable device 105. As an example, determining a quantity of resources used by the wearable device 105 to process data by a convolution layer (or a convolution) can be based on a size of the data (e.g., a number of bits, bytes, megabytes, etc.) and resources used to process a unit (e.g., a bit, byte, megabyte, etc.) of data by the convolution layer (or a convolution). The resources used to process a unit of data can be predetermined (e.g., previously measured) for the wearable device 105 and stored on the wearable device 105. The resources used to process a unit of data can be previously measured historical data of the wearable device 105.

In an example implementation, the machine learning processing manager 815 can communicate the data and information about the machine learning model 1305 (e.g., an identification of the machine learning model) and a processing status of the data (e.g., the next convolution layer to be used and a mapping of the data to the convolution or elements of the convolution). The communication can be directed to the machine learning processing manager 820 via the device client 305 and the core 420.

The comparison of resources used to communicate data to resources used to process data can be repeated for each convolution layer 1355-1, 1355-2, 1355-3, 1355-4 and/or each convolution 1315-1, 1315-2, 1315-3, 1320-1, 1320-2, 1320-3, 1325-1, 1325-2, 1325-3, 1330-1, 1330-2, and 1330-3. Moving the processing of the data by the convolution layer (or convolution) from the wearable device 105 to the companion device 110 can conserve resources of the wearable device 105.

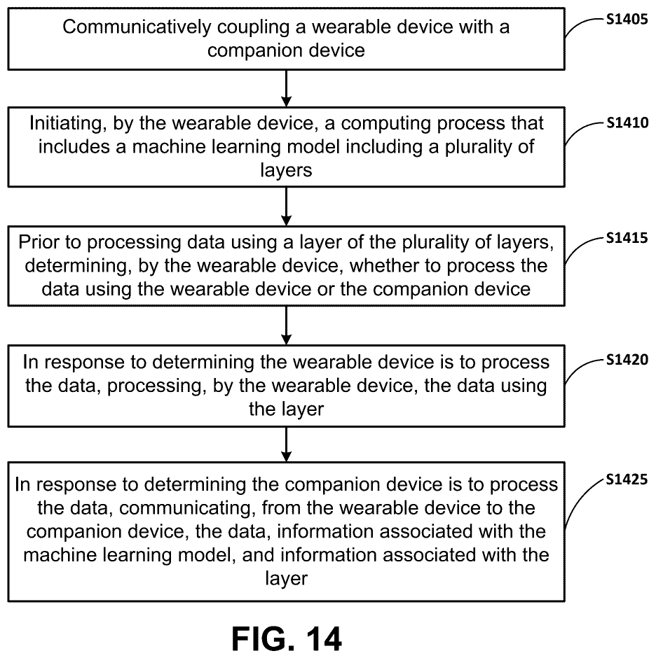

Example 36. FIG. 14 is a block diagram of a method of operating a wearable device according to an example implementation. As shown in FIG. 14, in step S1405 communicatively coupling a wearable device with a companion device. In step S1410 initiating, by the wearable device, a computing process that includes a machine learning model including a plurality of layers. In step S1415 prior to processing data using a layer of the plurality of layers, determining, by the wearable device, whether to process the data using the wearable device or the companion device. In step S1420 in response to determining the wearable device is to process the data, processing, by the wearable device, the data using the layer. In step S1425 in response to determining the companion device is to process the data, communicating, by the wearable device to the companion device, the data, information associated with the machine learning model, and information associated with the layer. A computing process can be initiated by a user of the wearable device providing corresponding user input (e.g., a gesture) to the wearable device. In some implementations, the wearable device can initiate the computing process based on another computing process, based on a spatial position of the wearable device, and/or the like. Causing a device to perform a task can include sending an instruction configured to initiate processing and/or trigger processing of a task by the device and/or another device(s). The information associated with the layer can include the machine learning model, an identification of the machine learning model, the layer identification (e.g., number), a mapping of data, a location of data, and/or the like). A map or mapping can link data to a neuron. The mapping can be a table, a database, a data structure, a linked list, and/or the like.

Example 37. The method of Example 36, wherein the initiating of the computing process can be triggered by receiving the data.

Example 38. The method of Example 36, wherein the wearable device can include the machine learning model, and the companion device includes the machine learning model.

Example 39. The method of Example 36, wherein the machine learning model can be a trained machine learning model.

Example 40. The method of Example 36, wherein the determining of whether to process the data using the wearable device or the companion device can include determining a first resource usage based on communicating the data from the wearable device to the companion device and determining a second resource usage based on processing the data using the layer on the wearable device.

Example 41. The method of Example 40, wherein the determining that the wearable device is to process the data can include determining the first resource usage is greater than the second resource usage.

Example 42. The method of Example 40, wherein the determining that the companion device is to process the data can include determining the second resource usage is greater than the first resource usage.

Example 43. The method of Example 36, wherein the wearable device can be smart glasses.

Example 44. The method of Example 36, wherein the companion device can be at least one of another wearable device, a mobile device, a smart phone, a tablet, a server, and a device including a processor and an operating system.

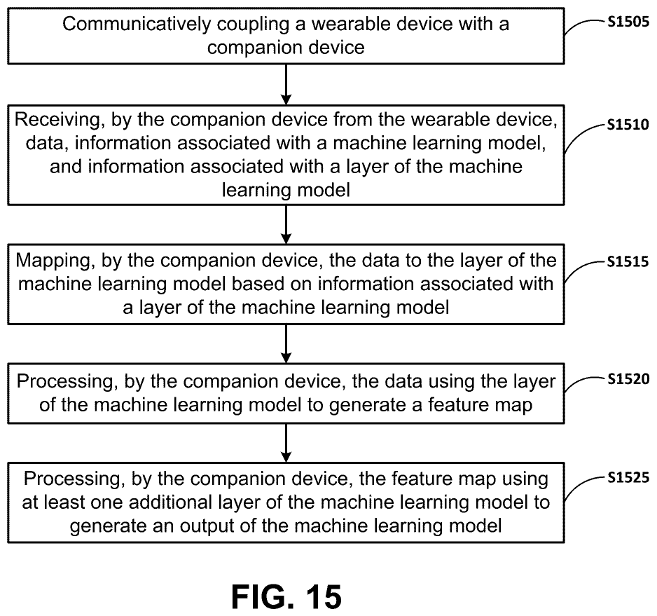

Example 45. FIG. 15 is a block diagram of a method of operating a companion device according to an example implementation. As shown in FIG. 15, in step S1505 communicatively coupling a wearable device with a companion device. In step S1510 receiving, by the companion device from the wearable device, data, information associated with a machine learning model, and information associated with a layer of the machine learning model. In step 1115 mapping, by the companion device, the data to the layer of the machine learning model based on the information associated with a layer of the machine learning model. Mapping can include, for example, using a table, a database, a linked list, a data structure, and/or the like to link, associate, and/or input data to respective neurons, convolutions, and the like of the layer. In step S1520 processing, by the companion device, the data using the layer of the machine learning model to generate a feature map. In step S1525 processing, by the companion device, the feature map using at least one additional layer of the machine learning model to generate an output of the machine learning model.

Example 46. The method of Example 45, wherein the wearable device can include the machine learning model, and the companion device includes the machine learning model.

Example 47. The method of Example 45, wherein the machine learning model can be a trained machine learning model.

Example 48. The method of Example 45, wherein the layer can include a plurality of plurality of neurons, and the mapping of the data includes inputting a portion of the data to a corresponding neuron of the plurality of neurons based on the information associated with a layer of the machine learning model.

Example 49. The method of Example 45, wherein the wearable device can be smart glasses.

Example 50. The method of Example 45, wherein the companion device can be at least one of another wearable device, a mobile device, a smart phone, a tablet, a server, and a device including a processor and an operating system.

Example 51. A method can include any combination of one or more of Example 36 to Example 50.

Example 52. A non-transitory computer-readable storage medium comprising instructions stored thereon that, when executed by at least one processor, are configured to cause a computing system to perform the method of any of Examples 36-51.

Example 53. An apparatus comprising means for performing the method of any of Examples 36-51.

Example 54. An apparatus comprising at least one processor and at least one memory including computer program code, the at least one memory and the computer program code configured to, with the at least one processor, cause the apparatus at least to perform the method of any of Examples 36-51.

Example 55. A method can include any combination of one or more of Example 36 to Example 50.

Example 56. A non-transitory computer-readable storage medium comprising instructions stored thereon that, when executed by at least one processor, are configured to cause a computing system to perform the method of any of Examples 1-55.

Example 57. An apparatus comprising means for performing the method of any of Examples 1-55.

Example 58. An apparatus comprising at least one processor and at least one memory including computer program code, the at least one memory and the computer program code configured to, with the at least one processor, cause the apparatus at least to perform the method of any of Examples 1-55.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal.

The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular implementations only and is not intended to be limiting of example implementations. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

What is claimed is:

1. A method comprising:
initiating a computing process on a wearable device, the computing process including a plurality of tasks;
identifying a companion device and determining that the companion device is available to perform at least one task of the plurality of tasks;
causing the companion device to perform the at least one task including communicating data generated by the wearable device to the companion device;
receiving, by the wearable device, a result associated with a completion of the at least one task by the companion device; and
completing, by the wearable device, the computing process based on the result associated with the completion of the at least one task.

2. The method of claim 1, wherein the result is a first result, the method further comprising:
receiving, by the wearable device, a second result associated with processing of the at least one task by the companion device;
processing, by the wearable device, the second result as processed second result; and
communicating, by the wearable device to the companion device, the processed second result, wherein the first result is based on the processed second result.

3. The method of claim 1, wherein the computing process is initiated by the wearable device.

4. The method of claim 1, wherein
the computing process is initiated by the companion device, and
initiating the computing process on the wearable device includes receiving a trigger from the companion device, by the wearable device.

5. The method of claim 1, wherein the data is associated with a peripheral device of the wearable device.

6. The method of claim 1, wherein
the wearable device includes a first socket,
the companion device includes a second socket communicatively coupled to the first socket,
causing the companion device to perform the at least one task includes writing an instruction and the data to the first socket, and
receiving the result associated with a completion of the at least one task includes reading the result from the second socket.

7. The method of claim 1, wherein the result includes an image, the method further comprising displaying the image on a display of the wearable device.

8. The method of claim 1, wherein the wearable device is smart glasses.

9. The method of any of claim 1, wherein the companion device is at least one of another wearable device, a mobile device, a smart phone, a tablet, a server, and a device including a processor and an operating system.

10. The method of claim 1, wherein
the companion device includes a virtual runtime environment,
causing the companion device to perform the at least one task includes causing the virtual runtime environment to perform the computing process, and
the result is the completion of the computing process, the method further comprising completing, by the wearable device, the computing process based on the result includes rendering an image on a display of the wearable device.

11. A system comprising:
a wearable device; and
a companion device,
the wearable device including:
a device client,
a hardware abstraction layer,
an operating system abstraction layer, and
and at least one peripheral device driver,
the companion device including a runtime environment associated with the wearable device, and
the system configured to:
initiate a computing process on the wearable device, the computing process including a plurality of tasks;
determine that the companion device is available to perform at least one task of the plurality of tasks;
communicate, by the wearable device, data generated by the wearable device to the companion device;
perform, by the companion device, the at least one task;
communicate, by the companion device, a result associated with a completion of the at least one task;
receive, by the wearable device, the result associated with the completion of the at least one task; and
complete, by the wearable device, the computing process based on the result associated with the completion of the at least one task.

12. The system of claim 11, wherein the companion device is a first companion device and the at least one task is at least one first task, the system further comprising:
a second companion device,
the system configured to cause the second companion device to perform at least one second task of the plurality of tasks.

13. The system of claim 12, wherein the first companion device and the second companion device are communicatively coupled.

14. The system of any of claim 11, wherein the wearable device is smart glasses.

15. The system of claim 11, wherein the companion device is at least one of another wearable device, a mobile device, a smart phone, a tablet, a server, and a device including a processor and an operating system.

16. The system of claim 11, wherein the runtime environment is a virtual runtime environment operating as a background process on the companion device.

17. The system of claim 16, wherein
the at least one task includes an application, and
the at least one task further includes processing an output of the application.

18. The system of claim 17, wherein processing the output of the application includes rendering an image on a display of the wearable device.

19. The system of claim 17, wherein the device client is configured to control communication associated with the application.

20. The system of claim 11, wherein the computing process is initiated by the wearable device.

21. The system of claim 11, wherein the computing process is initiated by the companion device.

22. A method comprising:
determining, by a companion device, that the companion device is available to perform at least one task of a plurality of tasks associated with a computing process;
receiving, by the companion device from a wearable device, data associated with the computing process generated by the wearable device;
performing, by the companion device, the at least one task; and
communicating, by the companion device to the wearable device, a result associated with a completion of the at least one task.

23. The method of claim 22, wherein the result is a first result, the method further comprising:
communicating, by the companion device to the wearable device, a second result associated with processing of the at least one task by the companion device;
receiving, by the companion device from the wearable device, processed second result; and
completing the at least one task by the companion device based on the processed second result, wherein the first result is based on the processed second result.

24. The method of claim 22, wherein the computing process is initiated by the wearable device.

25. The method of claim 22, wherein
the computing process is initiated by the companion device, the method further comprising communicating, by the companion device to the wearable device, a trigger associated with initiating the computing process.

26. The method of claim 22, wherein the data is associated with a peripheral device of the wearable device.

27. The method of claim 22, wherein
the wearable device includes a first socket,
the companion device includes a second socket communicatively coupled to the first socket, the method further comprising:
causing the companion device to perform the at least one task includes reading an instruction and the data from the second socket, and
communicating the result associated with a completion of the at least one task includes writing the result to the second socket.

28. The method of claim 22, wherein the result includes an image.

29. The method of claim 22, wherein
the companion device includes a virtual runtime environment operating as a background process on the companion device,
causing the companion device to perform the at least one task includes causing the virtual runtime environment to perform the plurality of tasks,
the result is the completion of the plurality of tasks.
